(19) United States
(12) Patent Application Publication
(10) Pub. No.: US 2009/0045533 A1
(43) Pub. Date: Feb. 19, 2009

(54) MOLD FOR MAKING A HOUSING AND METHOD FOR MAKING THE HOUSING

(75) Inventors: CHE-YUAN HSU, Shindian (TW); CHENG-WEN SU, Shindian (TW); YI-QIANG XU, Shenzhen (CN); ZHEN-YUAN ZHAI, Shenzhen (CN); GANG HUANG, Shenzhen (CN); LEI CHEN, Shenzhen (CN); HUAN-HONG XU, Shenzhen (CN); YAN-MIN WANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/960,663

(22) Filed: Dec. 19, 2007

(30) Foreign Application Priority Data
Aug. 15, 2007 (CN) 200710075699.8

(51) Int. Cl. B29D 11/00

(52) U.S. Cl. 264/1.7; 425/556

(57) ABSTRACT

A mold (20) for making a housing includes a female mold (22) and a rotatable male mold (24). The female mold has a first recessed mold portion (221) and a second recessed mold portion (222) defined therein. The male mold includes a first mold core (242), a second mold core (244), and a movable compression assembly (246). The first mold core has a first stepped portion (2422) and a second stepped portion (2424) protruding from the first stepped portion. The second mold core has a projection wall (2441) protruding from the male mold and a molding groove (2442) defined by the projection wall. The projection wall is matingly engageable into any one of the first recessed mold portion and the second recessed mold portion. The movable compression assembly is received in the molding groove and capable of moving towards to the female mold.

### BACKGROUND OF THE INVENTION

1. Field of the Invention

The present invention generally relates to molds, and particularly, to an injection mold for making a housing, and to a method for making the housing injection molding process.

2. Discussion of the Related Art

A conventional housing for an electronic device includes a housing portion and a transparent view panel. A display unit is received in the housing portion. The view panel covers the display unit, so as to protect the display unit from being damaged. The housing portion and the view panel are, respectively, manufactured by two separate molding processes. The view panel is adhered to the housing portion using adhesive in order to prevent the view panel from separating from the housing portion. However, the method of adhering the view panel to the housing portion cannot achieve a desired level of airproof and dustproof performance. Thus, moisture and dust in the ambient air can enter into the electronic device, which causes damage to the electronic device.

An injection molding process, allows molders to produce a housing with view panel integrally formed together, which can achieve a desired level of airproof and dustproof performance. During the injection molding process, a molten resin is injection molded to a housing portion of the housing, so as to form the view panel integrated with the housing. However, due to the difference of coefficient of thermal expansion between the view panel and the housing portion, micro wrinkles and/or stress may be generated between the view panel and the housing portion of the housing, during injection molding process. Micro wrinkles and/or stress may cause image aberration during use of the housing.

Therefore, an improved method and mold for making a housing are desired in order to overcome the above-described shortcomings.

### SUMMARY

In one embodiment thereof, a mold for making a housing is provided. The mold includes a female mold and a rotatable male mold. The female mold has a first recessed mold portion and a second recessed mold portion abreast defined therein. The first recessed mold portion is the same as the second recessed mold portion in configuration. The male mold includes a first mold core and a second mold core, which are respectively corresponding to the first recessed mold portion and the second recessed mold portion. The first mold core has a first stepped portion, a second stepped portion protruding from the first stepped portion, and a movable compression assembly. The second stepped portion has a width less than that of the first stepped portion. The second mold core has a projection wall protruding from the male mold and a molding groove defined by the projection wall. The projection wall is matingly engageable with any one of the first recessed mold portion and the second recessed mold portion. The molding groove has a configuration matingly engageable with the second stepped portion. The movable compression assembly is received in the molding groove of the second mold core and capable of moving towards to the female mold.

Other advantages and novel features will become more apparent from the following detailed description of preferred embodiments when taken in conjunction with the accompanying drawings.

### BRIEF DESCRIPTION OF THE DRAWINGS

Many aspects of the mold for making a housing can be better understood with reference to the following drawing. The components in the drawing are not necessarily drawn to scale, the emphasis instead being placed upon clearly illustrating the principles of the mold for making a housing. Moreover, in the drawing like reference numerals designate corresponding parts throughout the several views.

FIG. 1 is a cross-section view of a preferred embodiment of a mold for making a housing at an open state;

FIG. 2 is a cross-section view of a preferred embodiment of the mold shown in FIG. 1, at a closed state;

FIG. 3 is a schematic view of the mold shown in FIG. 2 with a substrate molded therein; and

FIG. 4 is a cross-section view of the mold shown in FIG. 2 with the substrate and a view lens molded therein.

### DETAILED DESCRIPTION OF THE PREFERRED EMBODIMENTS

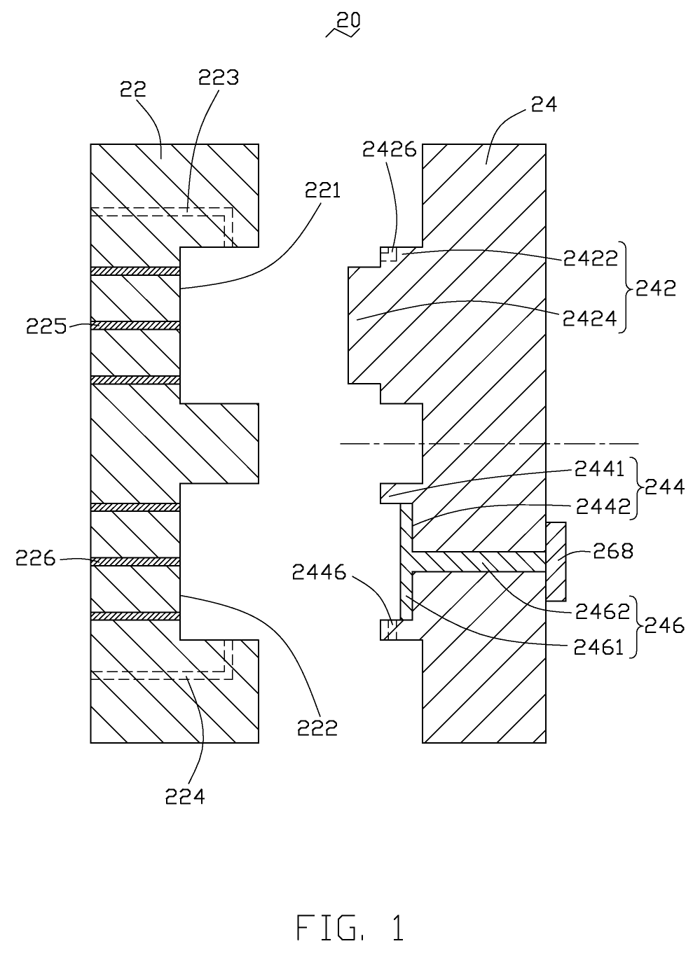

Referring to FIG. 1, in a present embodiment, a mold 20 includes a female mold 22 and a rotatable male mold 24 matingly engageable with the female mold 22.

The female mold 22 has a first recessed mold portion 221 and a second recessed mold portion 222 abreast defined therein. The first recessed mold portion 221 the second recessed mold portion 222 are disposed at a same side of the female mold 22. The first recessed mold portion 221 has a configuration the same as that of the second recessed mold portion 222. The female mold 22 also has at least a first runner 223 and at least a second runner 224 symmetrically defined therein, and has a first ejector pin 225 and a second ejector pin 226 mounted therein. The first runner 223 and the second runner 224 respectively communicate with the first recessed mold portion 221 and the second recessed mold portion 222, and configured (i.e., structured and arranged) for injecting molten resin into the first recessed mold portion 221 and the second recessed mold portion 222. The first ejector pin 225 and the second ejector pin 226 are respectively disposed below the first recessed mold portion 221 and the second recessed mold portion 222, and respectively configured (i.e., structured and arranged) for ejecting molded articles from the first recessed mold portion 221 and the second recessed mold portion 222.

The male mold 24 has a first mold core 242, a second mold core 244, and a movable compression assembly 246 mounted thereon. The first mold core 242 and a second mold core 244 are abreast disposed, and respectively corresponding to the first recessed mold portion 221 and the second recessed mold portion 222.

The first mold core 242 is formed into a stepped projection-shaped configuration, and configured (i.e., structured and arranged) for alternatively mating with the first recessed mold portion 221 and the second recessed mold portion 222. The first mold core 242 includes a first stepped portion 2422 and a second stepped portion 2424. The first stepped portion 2422 has at least a third runner 2426 formed therein. The third runner 2426 is corresponding to the first runner 223 and the second runner 224 of the female mold 22. When the first mold core 242 is alternatively mated with one of the first recessed mold portion 221 and the second recessed mold portion 222, the third runner 2426 is alternatively communicated with a corresponding one of the first runner 223 and the second runner 224. The first stepped portion 2422 is mounted on the male mold 24. The second stepped portion 2424 protrudes from the first stepped portion 2422 and has a width less than that of the first stepped portion 2422.

The second mold core 244 has a projection wall 2441 annularly protruding from the male mold 24 and a molding groove 2442 defined by the projection wall 2441. The projection wall 2441 has at least a fourth runner 2446 formed therein. The projection wall 2441 can be matingly engageable into any one of the first recessed mold portion 221 and the second recessed mold portion 222. When the first mold core 244 is alternatively mated with one of the first recessed mold portion 221 and the second recessed mold portion 222, the fourth runner 2446 is alternatively communicated with one of the first runner 223 and the second runner 224. The molding groove 2442 has a size corresponding to the second stepped portion 2424 of the first mold core 242.

The movable compression assembly 246 includes a press portion 2461 and a drive portion 2462. The press portion 2461 is received in the molding groove 2442, and configured for compressing a workpiece molded in the mold 20. The drive portion 2462 runs through the male mold 24. One end of the drive portion 2462 is fixed to the press portion 2461, with the other end being connected to a driving device (not shown) such as an air drive cylinder or a hydraulic drive cylinder.

An exemplary method for making a housing with a lens using the mold 20 is provided.

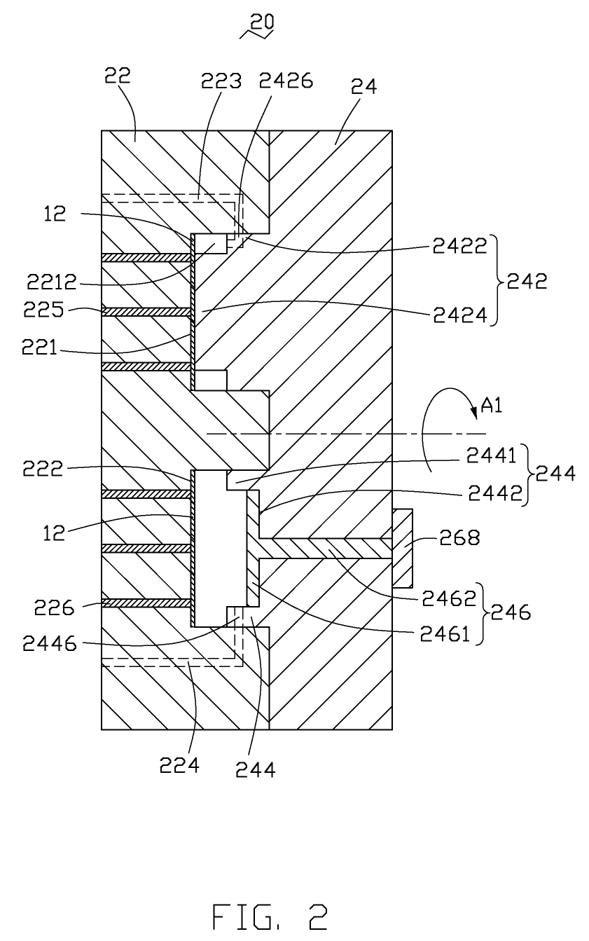

Firstly, referring to FIG. 2, two decorative sheets 12 are respectively attached to the first recessed mold portion 221 and the second recessed mold portion 222 of the female mold 22.

Secondly, the mold 20 is closed by engaging the male mold 24 with the female mold 22. The first mold core 242 of the male mold 24 is engaged into the first recessed mold portion 221. The second stepped portion 2424 of the first mold core 242 resists one of the decorative sheets 12 attached in the first recessed mold portion 221. The first recessed mold portion 221, the first stepped portion 2422, and the second stepped portion 2424 define a first molding cavity 2212, with the third runner 2426 of the second stepped portion 2424 communicating with the first molding cavity 2212. Correspondingly, the second mold core 244 of the male mold 24 is engaged into the second recessed mold portion 222.

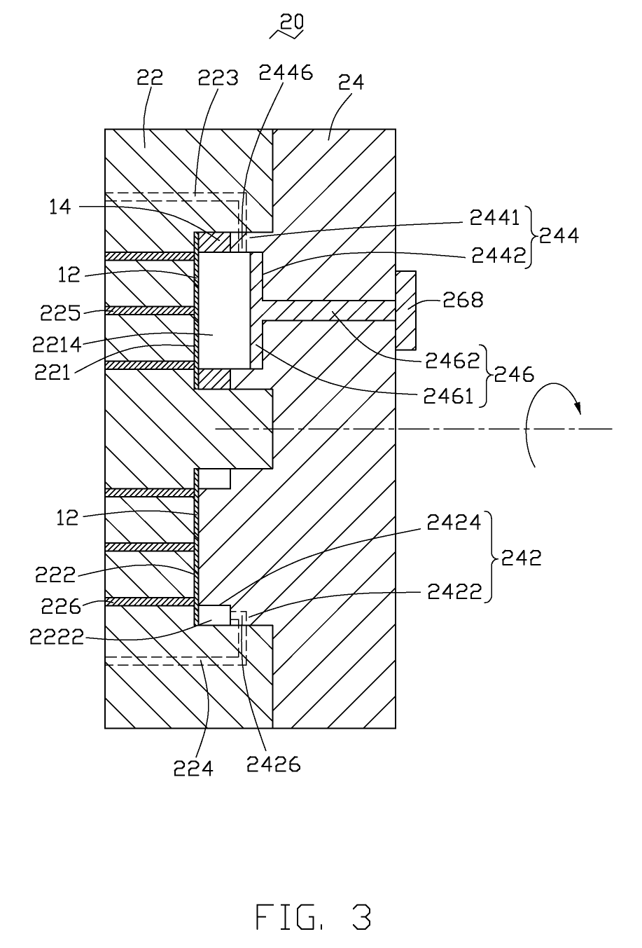

Thirdly, referring to FIG. 2 and FIG. 3, a first molten resin is injected into the first molding cavity 2212 via the first runner 223 and the third runner 2426 to form a substrate 14 integrated with the decorative sheet 12.

Fourthly, the male mold 24 is detached from the female mold 22 and rotated in an angle of 180° along a direction of A1 shown in FIG. 2. Thus, the first mold core 242 and the second mold core 244 are transposed with each other.

Fifthly, referring to FIG. 3, the second mold core 244 of the male mold 24 is engaged into the first recessed mold portion 221, with the projection wall 2441 of the second mold core 244 resisting the substrate 14. Thus, a second molding cavity 2214 is defined by the first recessed mold portion 221, the projection wall 2441 of the second mold core 244, and the movable compression assembly 246 received in the molding groove 2442. Simultaneously, the first mold core 242 of the male mold 24 is engaged into the second recessed mold portion 222. The second stepped portion 2424 of the first mold core 242 resists one of the decorative sheets 12 attached in the second recessed mold portion 221. Thus, the second recessed mold portion 222, the first stepped portion 2422, and the second stepped portion 2424 of the first mold core 242 define a third molding cavity 2222.

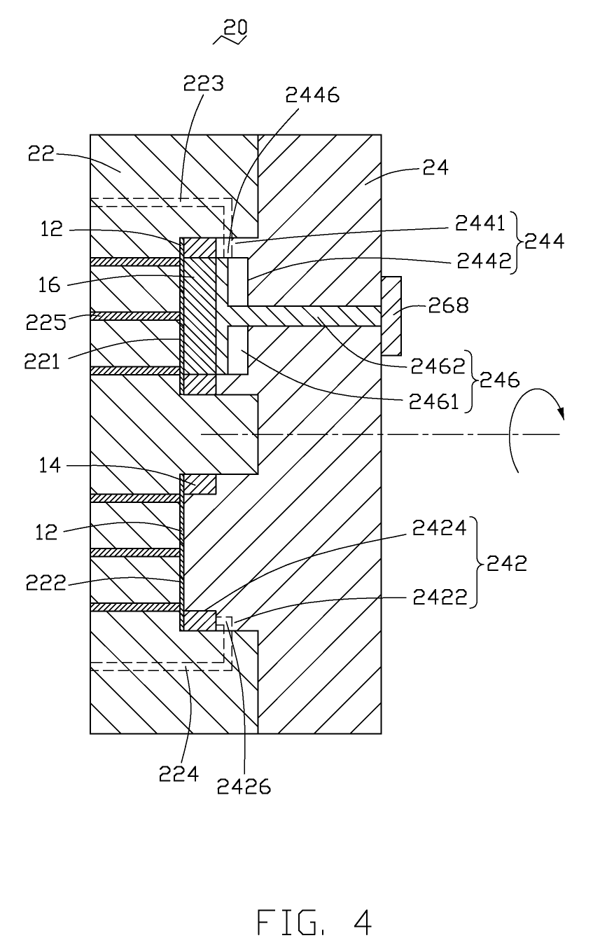

Referring to FIG. 4, sixthly, a transparent moldable material such as a clear resin is injected into the second molding cavity 2214 via the first runner 223 and the fourth runner 2446 to form a view lens 16 integrated with the substrate 14 and the decorative sheet 12.

Seventhly, the view lens 16 integrated with the substrate 14 and the decorative sheet 12 is cooled within the mold 20. During cooling the view lens 16, the movable compression assembly 246 is moved towards the first recessed portion 221, so as to compress the view lens 16 molded in the first recessed portion 221. The compression of the view lens 16 reduces the chances of micro wrinkles and/or stress generated between the view lens 16 and the substrate 14. Thus, any potential image aberration caused by the micro wrinkles and/or stress of the view lens 16 can be reduced. As such, a housing 10 consisting of the decorative sheet 12, the substrate 14, and the view lens 16 is formed.

It should be understood that, during the sixth step of injection molding the view lens 16, the first molten resin can also be injected into the third molding cavity 2222 via the second runner 224 and the third runner 2426 to form a second substrate the same as the substrate 14. Thus, after the seventh step, the mold 24 is opened and further rotated in an angle of 180°, and the manufacturing circulation of the housing 10 can be continued by performing steps similar to the steps of fifth to seventh.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mold for making a housing, comprising:
a female mold having a first recessed mold portion and a second recessed mold portion defined at a same side thereof, the first recessed mold portion being the same as the second recessed mold portion in configuration;
a rotatable male mold matingly engageable with the female mold, the male mold comprising:
a first mold core corresponding to one of the first recessed mold portion and the second recessed mold portion, the first mold core having a first stepped portion and a second stepped portion, the second stepped portion protruding from the first stepped portion and having a width less than that of the first stepped portion; and
a second mold core having a projection wall protruding from the male mold and a molding groove defined by the projection wall, the projection wall being matingly engageable with any one of the first recessed mold portion and the second recessed mold portion, the molding groove having a configuration matingly engageable with the second stepped portion; and
a movable compression assembly being received in the molding groove of the second mold core and capable of moving towards to the female mold.

2. The mold as claimed in claim 1, wherein the female mold has at least a first runner and at least a second runner symmetrically defined therein, which respectively communicate with the first recessed mold portion and the second recessed mold portion.

3. The mold as claimed in claim 1, wherein the female mold has a first ejector pin and a second ejector pin, which are respectively disposed below the first recessed mold portion and the second recessed mold portion, and respectively configured for ejecting workpieces from the first recessed mold portion and the second recessed mold portion.

4. The mold as claimed in claim 2, wherein the first stepped portion has at least one third runner formed therein, which is capable of alternatively communicating with one of the first runner and the second runner.

5. The mold as claimed in claim 2, wherein the projection wall has at least one fourth runner formed therein, the at least one fourth runner being capable of alternatively communicating with one of the first runner and the second runner.

6. The mold as claimed in claim 1, wherein the movable compression assembly includes a press portion and a drive portion, the press portion being received in the molding groove, the drive portion running through the male mold, one end of the drive portion being fixed to the press portion, the other end of the drive portion being connected to a driving device.

7. The mold as claimed in claim 6, wherein a driving device is an air drive cylinder or a hydraulic drive cylinder.

8. A method for making a housing with a view lens, comprising steps of:
providing a mold, the injection mold having a female mold and a rotatable male mold matingly engageable with the female mold, the female mold having at least one recessed mold portion, the male mold having a first mold core, a second mold core, and a movably compression assembly, the first mold core being configured for molding a housing portion of the housing, the second mold core being configured for molding the view lens and having a molding groove, the movable compression assembly being received in the molding groove of the second mold core and capable of moving towards to the female mold;
fixing a decorative sheet into the recessed mold portion;
closing the mold by engaging the female mold with the rotatable male mold, with the first mold core engaging into the recessed mold portion;
injecting a molten moldable material into the recessed mold portion to form a substrate;
opening the mold and rotating the male mold in such manner that the first mold core and the second mold core are transposed with each other;
closing the mold by engaging the female mold with the rotatable male mold, with the second mold core engaging into the recessed mold portion having the substrate molded therein; and
injecting a transparent moldable material into the recessed mold portion to form a view lens integrated with the decorative sheet and the substrate;
moving the compression assembly towards the female mold to compress the view lens; and
cooling the view lens and the substrate.

9. The method as claimed in claim 8, wherein the female mold has a first recessed mold portion, a second recessed portion, at least a first runner, and at least a second runner, the first runner and the second runner being respectively communicated with the first recessed mold portion and the second recessed mold portion.

10. The method as claimed in claim 9, wherein the female mold has a first ejector pin and a second ejector pin, which are respectively disposed below the first recessed mold portion and the second recessed mold portion, and configured for ejecting workpieces from the first recessed mold portion and the second recessed mold portion.

11. The method as claimed in claim 9, wherein the first stepped portion has at least one third runner formed therein, which is capable of alternatively communicating with one of the first runner and the second runner.

12. The method as claimed in claim 9, wherein the projection wall has at least one fourth runner formed therein, at least one fourth runner being capable of alternatively communicating with one of the first runner and the second runner.

13. The method as claimed in claim 8, wherein the movable compression assembly includes a press portion and a drive portion, the press portion being received in the molding groove, the drive portion running through the male mold, one end of the drive portion being fixed to the press portion, the other end of the drive portion being connected to a driving device.

14. The method as claimed in claim 8, wherein the transparent moldable material is a clear resin.
